(19) United States
(12) Patent Application Publication
(10) Pub. No.: US 2026/0018793 A1
(43) Pub. Date: Jan. 15, 2026

(54) ULTRA-DENSE TRIBAND UNIT CELL

(71) Applicant: JOHN MEZZALINGUA ASSOCIATES, LLC., Liverpool, NY (US)

(72) Inventors: Jiaqiang ZHU, Baldwinsville, NY (US); Wengang CHEN, Jamesville, NY (US)

(21) Appl. No.: 19/333,581

(22) Filed: Sep. 19, 2025

Related U.S. Application Data
(63) Continuation-in-part of application No. 18/863,573, filed on Jan. 1, 0001.
(60) Provisional application No. 63/499,458, filed on May 1, 2023.

(51) Int. Cl. H01Q 5/48; H01Q 5/20; H01Q 21/26

(52) U.S. Cl. CPC H01Q 5/48; H01Q 5/20; H01Q 21/26

(57) ABSTRACT

A unit cell for an ultra-dense multiband antenna comprises a reflector; a first frequency dipole disposed on the reflector, the first frequency dipole having four first frequency dipole arms; a plurality of second frequency dipoles disposed on the reflector, each of second frequency dipoles having four second frequency dipole arms; and a plurality of third frequency radiators disposed on the reflector, each third frequency radiator having a patch antenna element that is disposed above the reflector and a cavity cup frame disposed below the reflector, wherein each of the first frequency dipole arms is disposed above a second frequency dipole, and wherein each of the second frequency dipole arms is disposed above a third frequency radiator.

### CROSS-REFERENCE TO RELATED APPLICATIONS

This application is a Continuation-in-Part of U.S. application Ser. No. 18/863,573, filed Nov. 6, 2024, which is a U.S. National Stage Application of International Application No. PCT/US24/26965, filed Apr. 30, 2024, which claims priority to U.S. Provisional Application 63/499,458, filed May 1, 2023, all of which are incorporated herein by reference.

### BACKGROUND OF THE INVENTION

Modern cellular antennas typically operate in three frequency bands: low band (LB) (617-894 MHZ), mid band (MB) (1695-2690 MHZ), C-Band and CBRS (Citizens Broadband Radio Service) (3.4-4.2 GHZ). Of these, the C-Band array is typically arranged in an 8T8R (Eight Transmit Eight Receive) configuration having multiple columns of radiators in an array to provide beamforming and beam steering in the azimuth plane. Further, the MB radiators are typically arranged in two columns whereby it is preferable for each column to have numerous radiators to enable beam tilt in the vertical plane.

A challenge arises in the design of multiband antennas in that there is pressure to minimize the area of the multiband antenna array to reduce wind loading. Accordingly, it is desirable to make the antenna array as dense as possible. However, placing the radiators of the three bands in close proximity causes interference between them. An example of such interference is between the MB radiators and the C-Band radiators. Conventional solutions to the MB/C-Band interference problem involve either truncating the MB array to keep the MB radiators at a distance from the C-Band array, or increasing the spacing between the MB and C-Band arrays. The former solution reduces the number of MB radiators in the antenna and thus limits the MB gain and beam quality, and the latter solution increases the size of the antenna, exacerbating its wind loading as well as increasing its weight.

Accordingly, what is needed is a MB and C-Band dipole design that allows for adjacent placement of the respective radiators without degrading performance of each.

### SUMMARY OF THE INVENTION

An aspect of the present disclosure involves a unit cell for a multiband antenna. The unit cell comprises a reflector; a first frequency dipole disposed on the reflector, the first frequency dipole having four first frequency dipole arms; a plurality of second frequency dipoles disposed on the reflector, each of second frequency dipoles having four second frequency dipole arms; and a plurality of third frequency radiators disposed on the reflector, each third frequency radiator having a patch antenna element that is disposed above the reflector and a cavity cup frame disposed below the reflector, wherein each of the first frequency dipole arms is disposed above a second frequency dipole, and wherein each of the second frequency dipole arms is disposed above a third frequency radiator.

Another aspect of the present disclosure involves a unit cell cluster for a multiband antenna. The unit cell cluster includes a plurality of unit cells. Each of the unit cells, in turn, has a reflector; a single cloaked Low Band dipole having four Low Band dipole arms; a plurality of cloaked Mid-Band dipoles, each having four Mid-Band dipole arms; and a plurality of C-Band radiators, each having a patch antenna element disposed above the reflector and a cavity cup frame disposed below the reflector. Each of the Low Band dipole arms is disposed above a corresponding one of the plurality of Mid-Band dipoles, and each of the Mid-Band dipole arms is disposed above a corresponding one of the plurality of C-Band radiators.

### BRIEF DESCRIPTION OF DRAWINGS

FIG. 1A illustrates an exemplary dual-band antenna array portion having a plurality of exemplary aperture-fed patches according to the disclosure.

FIG. 1B illustrates the exemplary dual-band antenna array portion of FIG. 1A from along a vertical plane defined by a y-axis and a z-axis.

FIG. 1C illustrates the exemplary dual-band antenna array portion along a vertical or y-axis.

FIG. 2 illustrates an exemplary feed and cavity assembly according to the disclosure, viewed along the vertical y-axis.

FIG. 3A is a top-down view of the feed circuitry of an exemplary dual-band antenna array portion according to the disclosure.

FIG. 3B is a top-down transparent view of an exemplary dual patch C-Band unit cell, shown as one of four such unit cells within the dual-band antenna array portion.

FIG. 3C further illustrates a top-down transparent view of an exemplary dual patch unit cell according to the disclosure.

FIG. 4 illustrates an exemplary feed trace layer for the disclosed dual patch unit cell.

FIG. 5 illustrates an exemplary feed aperture layer for the disclosed dual patch unit cell.

FIG. 6 illustrates an exemplary cavity cup layer for the disclosed dual patch unit cell.

FIG. 7 illustrates an exemplary cavity ground plane layer for the disclosed dual patch unit cell.

FIG. 8 illustrates an exemplary C-Band patch assembly having four C-Band patches.

FIG. 9A illustrates an exemplary MB (Mid Band) dipole that may be deployed as part of the exemplary dual-band antenna array portion.

FIG. 9B illustrates a first metal layer pattern for the exemplary MB dipole of FIG. 9A.

FIG. 9C illustrates a second metal layer pattern for the exemplary MB dipole of FIG. 9A.

FIG. 9D provides exemplary dimensions for the first metal pattern of FIG. 9B.

FIG. 9E provides exemplary dimensions for the second metal layer pattern of FIG. 9C.

FIG. 10 illustrates a cluster of exemplary ultra-dense triband unit cells according to the disclosure.

FIG. 11A illustrates an exemplary triband unit cell according to the disclosure.

FIG. 11B is a view of the triband unit cell of FIG. 11A, viewed along the vertical (z) axis.

FIG. 12A illustrates an exemplary cloaked Low Band dipole configured to be integrated into the disclosed triband unit cell.

FIG. 12B is a view of the cloaked Low Band dipole of FIG. 12A along the vertical (z) axis.

FIG. 13A illustrates the PCB (Printed Circuit Board) substrate of the cloaked Low Band dipole with the upper conductor pattern disposed thereon.

FIG. 13B is a zoomed in view of FIG. 13A, showing further detail of the upper conductor pattern.

FIG. 14 illustrates the lower conductor pattern of the cloaked Low Band dipole of the disclosure.

FIG. 15 illustrates a single dipole arm of the lower conductor pattern of FIG. 14.

FIG. 16A illustrates an exemplary cloaked Mid Band dipole configured to be integrated into the disclosed triband unit cell.

FIG. 16B illustrates the PCB substrate and upper conductor pattern of the cloaked Mid Band dipole of FIG. 16A.

FIG. 16C illustrates the lower conductor pattern for the cloaked Mid Band dipole of FIG. 16A.

FIG. 16D illustrates the lower conductor pattern for a single dipole arm of the lower conductor pattern of FIG. 16C.

FIG. 17 illustrates two C-Band radiators, showing two patch antenna elements disposed atop two cavity cup frames.

### DETAILED DESCRIPTION OF THE INVENTION

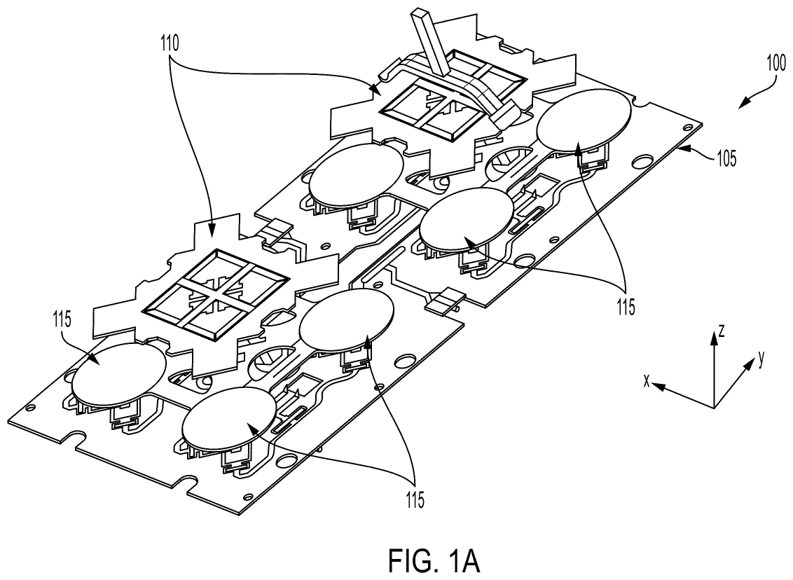

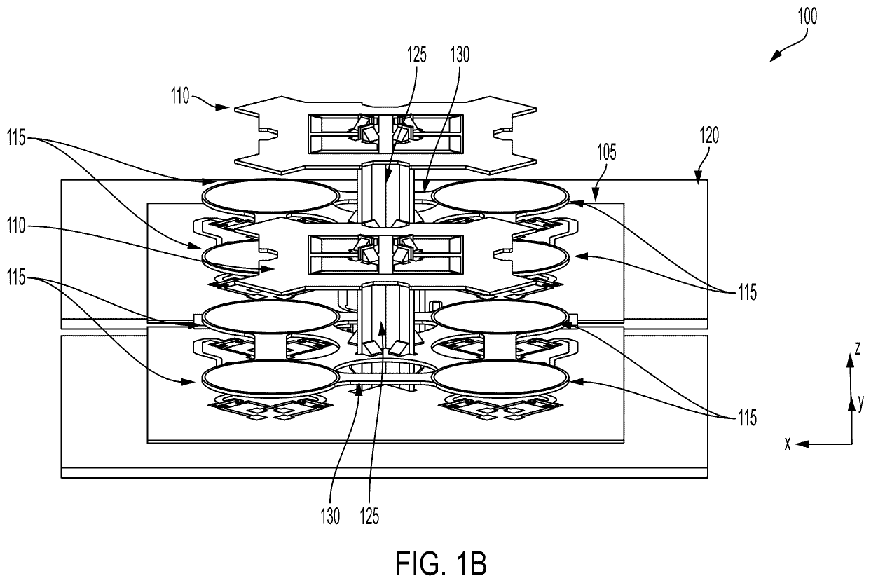

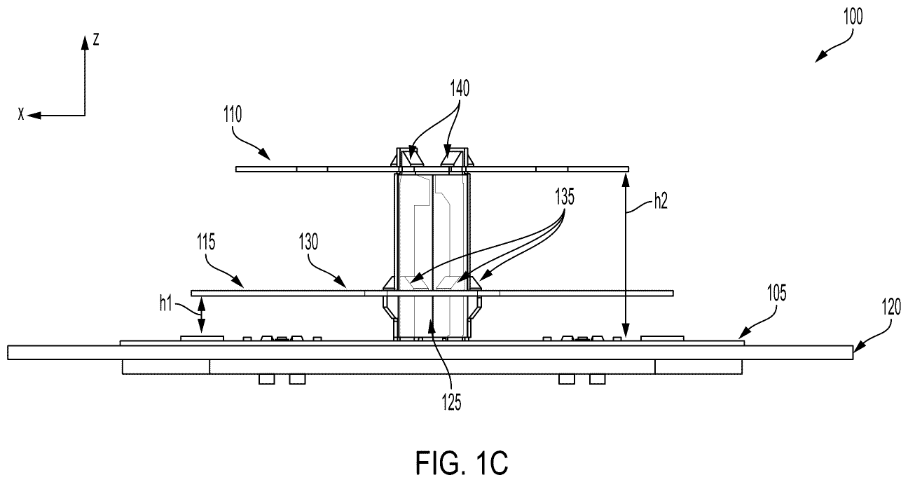

FIG. 1A illustrates an exemplary dual-band antenna array portion 100 having a plurality of exemplary aperture-fed patches according to the disclosure. Array portion 100 has a feed and cavity assembly 105 on which are disposed two exemplary MB dipoles 110 and eight exemplary C-Band patch antenna elements 115 according to the disclosure. Array portion 100 may serve as a unit cell for a larger antenna array that may have multiple iterations of array portion 100 mounted adjacent to each other along the y-axis (vertical axis) for increased gain and finer beam control for tilting the beam in the vertical plane (defined by the y-axis and z-axis) using a Remote Electrical Tilt mechanism (not shown). Further, multiple array portions 100 may alternately or additionally be mounted adjacent to each other along the x-axis (azimuth axis) to provide for a narrow beam and finer beam steering in the azimuth plane (defined by the x-axis and z-axis). In an exemplary embodiment, the C-Band patch antenna elements 115 may be spaced apart along both the x-axis and the y-axis by 52.5 mm, and the MB dipoles 110 may be spaced apart along both the x-axis and the y-axis by 105 mm.

FIG. 1B illustrates array portion 100 from an angle along the vertical plane defined by the y-axis and z-axis. Shown in FIG. 1B is a reflector 120 on which feed and cavity assembly 105 is disposed. Also visible in FIG. 1B are two balun stems 125, each supporting a corresponding MB dipole 110; and two frames 130, each holding four patch antenna elements 115, and each mechanically supported by a balun stem 125.

FIG. 1C is a side view of array portion 100, as seen along the y-axis (vertical axis). Visible in FIG. 1C are reflector 120 with integrated feed and cavity assembly 105; balun stem 125 that supports MB dipole 110 and also support patch antenna frame 130. Patch antenna frame 130 holds patch antenna elements 115 and mounts to balun stem 125 by support solder joints 135. Support solder joints 135 do not conduct any signal and may mechanically coupling patch antenna frame 130 to balun stem 125. MB dipole 110 is both mechanically and electrically coupled to balun stem 125 by signal solder joints 140 and may be mounted at height h2 above reflector 120. Patch antenna frame 130 may be mounted so that patch antenna elements 115 may be elevated above reflector 120 at a height h1. In an exemplary embodiment, h1 may be 8.38 mm, and h2 may be 28.26 mm

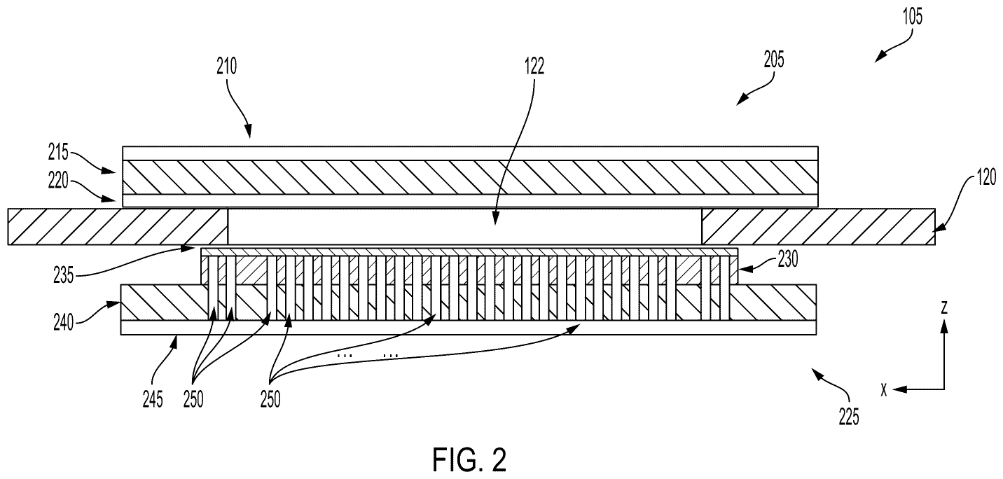

FIG. 2 is a cross sectional view of exemplary feed and cavity assembly 105 according to the disclosure. Feed and cavity assembly 105 has two PCB (Printed Circuit Board) structures that are mechanically coupled to reflector 120: an upper PCB structure 205 disposed on an upper surface of reflector 120; and a lower PCB structure 225 disposed on a lower surface of reflector 120. Upper PCB structure 205 has a PCB 215. Disposed on the upper surface of PCB 215 is a feed trace metal layer 210; and disposed on the lower surface of PCB 215 is an aperture metal layer 220. Lower PCB structure 225 has a lower PCB 240 on which is disposed a dielectric cavity cup frame 230 on its upper surface and a lower cavity ground plane layer 245 on its lower surface. Formed within lower PCB 240 and cavity cup frame 230 is a plurality of vias 250. Vias 250 are filled with metal and electrically couple to lower cavity ground plane layer 245. Disposed on top of dielectric cavity cup frame 230 and vias 250 is a solder mask 235, which provides isolation for better performance and mitigation of PIM (Passive InterModulation distortion).

As illustrated, reflector 120 may have an aperture 122 that exposes upper PCB structure 205 to lower PCB structure 225. The dimensions of aperture 122 may be the same as the inner dimension of cavity cup frame 230.

The structure illustrated in FIG. 2 corresponds to a single patch antenna element 115.

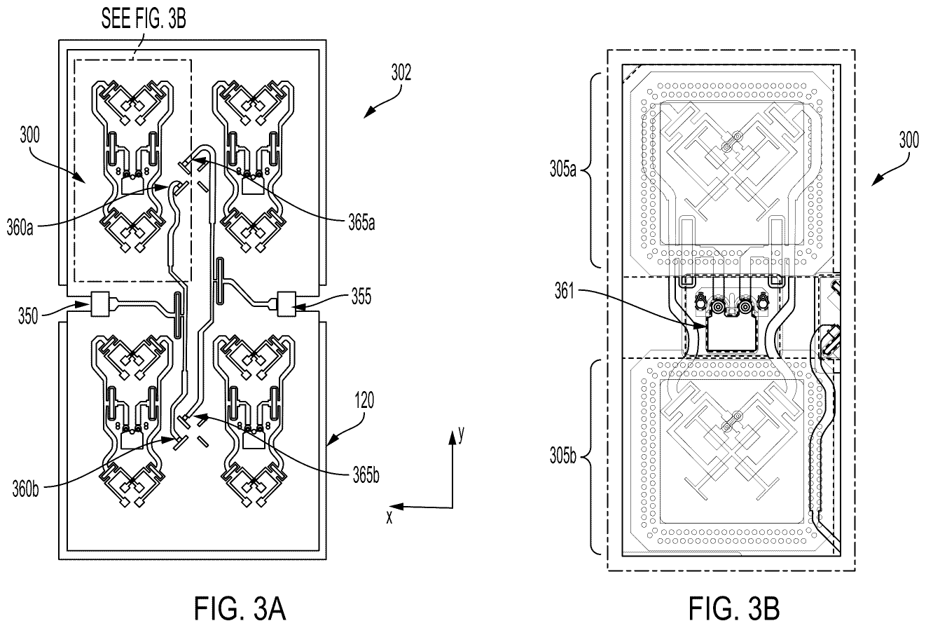

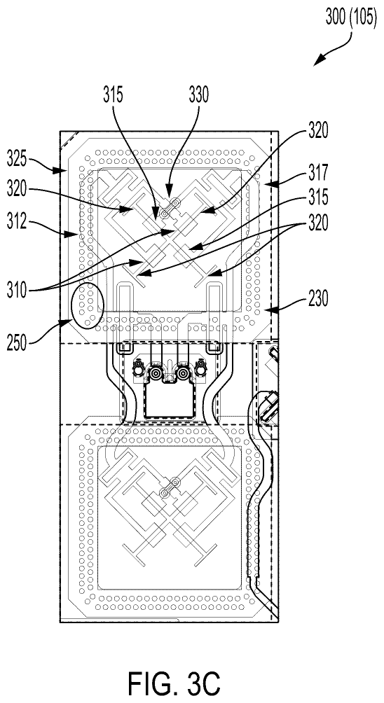

FIG. 3A is a top-down view of the feed circuitry 302 of an exemplary dual-band antenna array portion 100 according to the disclosure. Array portion 100 has four C-Band unit cells 300, one of which is highlighted by dotted line box A. Feed circuitry 302 also supports two MB dipoles (not shown). MB signal feeds include an MB+45 signal feed 350 that electrically couples to a first MB dipole+45 signal feed 360a and a second MB dipole+45 signal feed 360b, and an MB −45 signal feed 355 that couples to a first MB dipole −45 signal feed 365a and a second MB dipole −45 signal feed 365b.

FIG. 3B illustrates the signal and cavity assembly 105 for one C-Band unit cell 300, as broken out from dotted line box A in FIG. 3A. C-Band unit cell 300 is illustrated in FIG. 3B in transparency to show the overlapping structures in signal and cavity assembly 105. C-Band unit cell 300 has a first sub-unit 305a corresponding to a first patch antenna element 115 and a second sub-unit 305b corresponding to a second patch antenna element 115. The first and second patch antenna elements 115 are fed the same two signals (+/−45 degree polarization) through feeds provided by two RF (Radio Frequency) cables (not shown) that couple at aperture 361 formed in signal and cavity assembly 105 and reflector 120.

FIG. 3C is substantially similar to FIG. 3B, showing each constituent layer within feed and cavity assembly 105 superimposed over each other, whereby each layer is also illustrated in cross section in FIG. 2. For the purposes of illustration, the RF feed structure for the first sub-unit 305a is described herein. It will be understood that the same description applies to the mirrored feed structure of second sub-unit 305b.

The RF signal for a +45 polarization state has a +45 signal feed 312 that splits into two feed branches that terminate in two +45 feed pads 310. Both +45 feed pads 310 are superimposed over the +45 arm of cruciform aperture 320 that is formed in aperture metal layer 220. Similarly, the RF signal for a −45 polarization state has a −45 signal feed 317 that splits into two feed branches that terminate in two −45 feed pads 315. Both −45 feed pads 310 are superimposed over the −45 arm of cruciform aperture 320. The +45 signal feed 312, both +45 feed pads 310, −45 signal feed 317, and both −45 feed pads 315 are formed of metal in feed trace metal layer 210. As illustrated above in FIG. 2, feed trace metal layer 210 and aperture metal layer 220 are respectively disposed on an upper and lower surface of PCB 215, forming upper PCB structure 205.

As illustrated, each of first sub-unit 305a and second sub-unit 305b has an intersection 330 of two feed branches (one for the +45 signal and the other for the −45 signal) that cross. To accommodate this, a bridge and via structure may be used to pass one of the two signals through a set of vias through PCB 215 and carried briefly through an isolated portion of aperture metal layer 220.

Also shown in FIG. 3C is cavity cup frame 230 and its plurality of vias 250. As discussed above with respect to FIG. 2, cavity cup frame 230 is formed on the underside of reflector 120 and is disposed on the upper surface of lower PCB 240; and metal-filled vias 250 pass through both cavity cup frame 230 and lower PCB 240 to electrically couple with lower cavity ground plane layer 245 that is disposed on the lower surface of lower PCB 240. This structure creates an RF cavity that reflects RF energy (+45 and −45 polarized signals) emitted downward in the negative z-axis direction from aperture metal layer 220 toward lower cavity ground plane layer 245. The cavity formed by cavity cup frame 230, vias 250, and lower cavity ground plane layer 245 reflects the emitted energy upward in the positive z-axis direction, combining with the RF energy emitted in the positive z-direction by aperture metal layer 220 to feed the patch antenna element 115 disposed above the cruciform aperture 320.

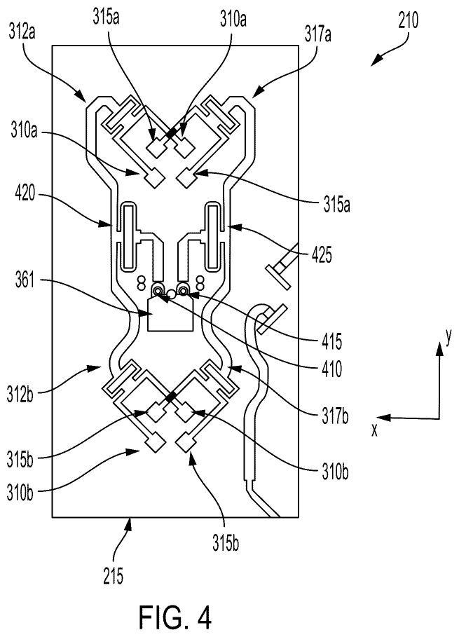

FIG. 4 illustrates an exemplary feed trace layer 210 for the disclosed dual patch unit cell 300. The illustrated traces may be formed in a metal layer disposed on an upper surface of PCB 215, which is illustrated as a background to the traces. Illustrated in FIG. 4 is aperture 361 by which two RF cables (not shown) may be connected to couple a +45 RF signal to +45 signal input 410 and a −45 RF signal to −45 signal input 415. The trace from +45 signal input 410 splits at junction 420 and is divided into two +45 signal feeds 312a and 312b, which respectively couple to +45 feed pads 310a and 310b as described above with respect to FIG. 3C. Similarly, the trace from −45 signal input 415 splits at junction 425 and is divided into two −45 signal feeds 317a and 317b, which respectively couple to −45 feed pads 315a and 315b.

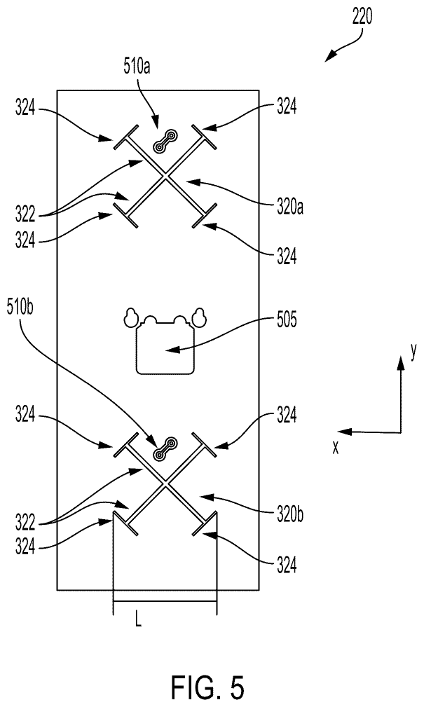

FIG. 5 illustrates an exemplary aperture metal layer 220 according to the disclosure. Aperture metal layer 220 has an aperture 505 for two RF cables (not shown) to pass through for coupling to RF signal inputs 410 and 415 (also not shown). Aperture metal layer 220 has a first cruciform aperture 320a corresponding to first sub-unit 305a and a second cruciform aperture 320b corresponding to a second sub-unit 305b. Each cruciform aperture 320a/b may have two diagonal arms 322 that have transverse arms 324 at their ends. In an exemplary embodiment, diagonal arms 322 may have a length of 19.4 mm and a width of 0.71 mm. Transverse arms 324 may have a width of 0.34 mm. Transverse arms 324 may have a length such that the distance from their respective furthest ends (dimension L) may be 14.46 mm. Aperture metal layer 220 also has a first signal bridge 510a and second signal bridge 510b. First signal bridge 510a and second signal bridge 510b carry the signal trace of one of the signals that would otherwise intersect at intersections 330. In an exemplary embodiment, aperture metal layer 220 may be formed of Copper having a 1.4 mil thickness.

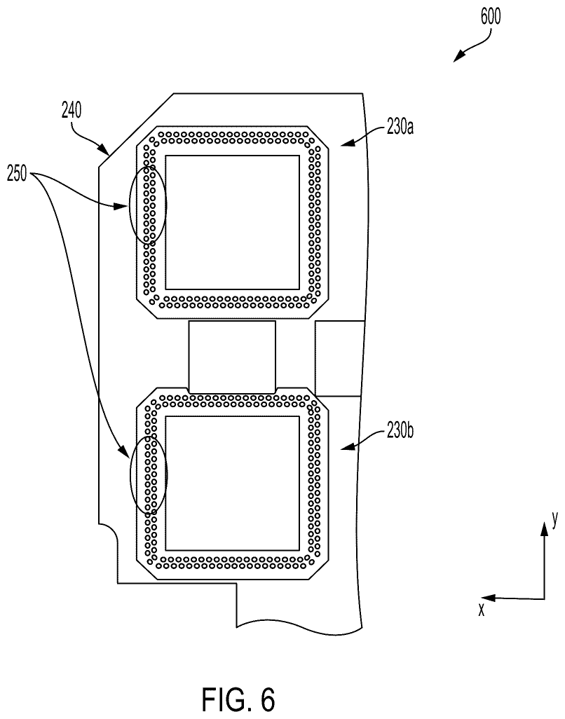

FIG. 6 illustrates an exemplary cavity cup frame layer 600. For the illustrated C-Band unit cell 300, cavity cup frame layer has a first cavity cup frame 230a and a second cavity cup frame 230b, both of which are disposed on an upper surface of lower PCB 240, and each of which respectively corresponds to sub-unit 305a and 305b. The use of a high dielectric material in cavity cup frame 230 provides for a cavity that is shallower than could otherwise be employed in the case of a conductive cup frame. In an exemplary embodiment, cavity cup frames 230a/b may be formed of an FR4 PCB material with a dielectric constant of 4.2. Also illustrated are vias 250 that are formed within first and second cavity cup frames 230a/b. Vias 250 may be arranged in two rows or columns such that the vias within each row/column are offset from each other and alternating.

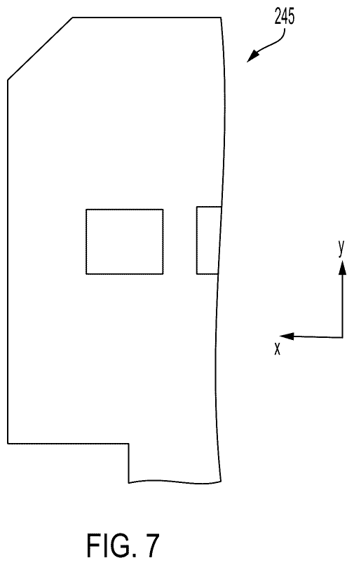

FIG. 7 illustrates an exemplary lower cavity ground plane layer 245 for a C-Band unit cell 300 according to the disclosure. Lower cavity ground plane layer 245 is disposed on a lower surface of lower PCB 240. The vias 250 shown in FIG. 6 electrically couple to lower cavity ground plane 245. In an exemplary embodiment, lower cavity ground plane layer 245 may be formed of Copper having a thickness of 1.4 mil.

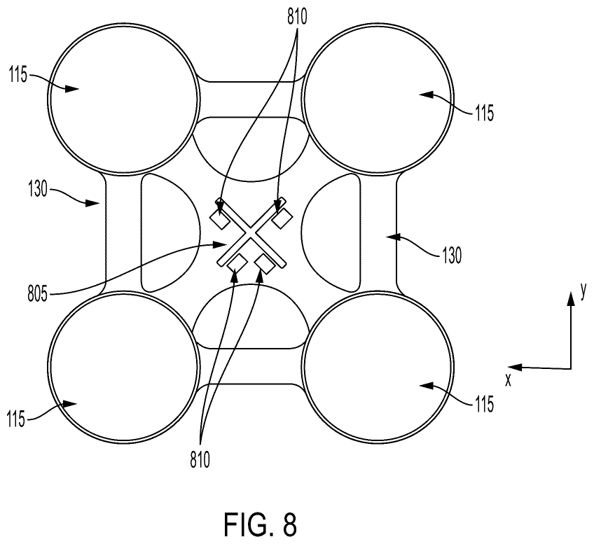

FIG. 8 illustrates an exemplary C-Band patch assembly 800 having a patch frame 130 that holds four C-Band patches 115. Patch frame 130 may be formed of a PCB or dielectric that may have a cruciform slot 805 through which balun stem 125 (not shown) may be inserted. Patch frame 130 may also have a plurality of solder points 810 for soldering patch frame 130 to balun stem 125 (not shown). In an exemplary embodiment, patch frame 130 may be formed of a 30 mil DK 4.2 PCB; and C-Band patches 115 may be formed of two Copper layers, each with a thickness of 1.4 mil and have a radius of 14.36 mm. The two Copper layers forming C-Band patch may be disposed above and below patch frame 130 in a sandwich configuration.

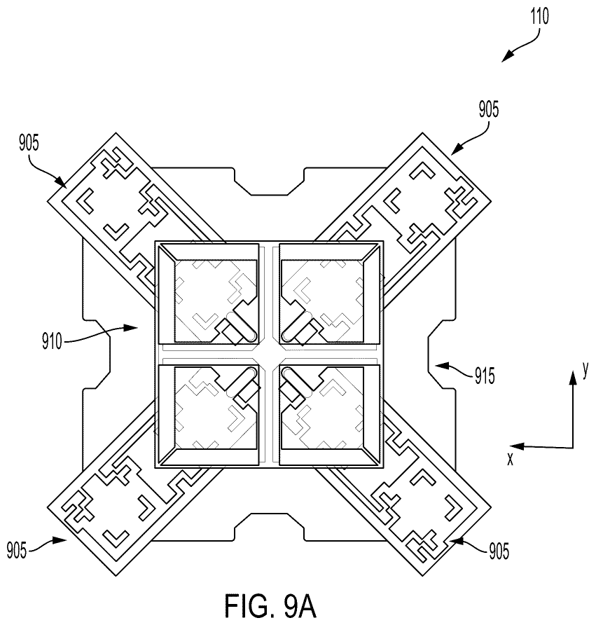

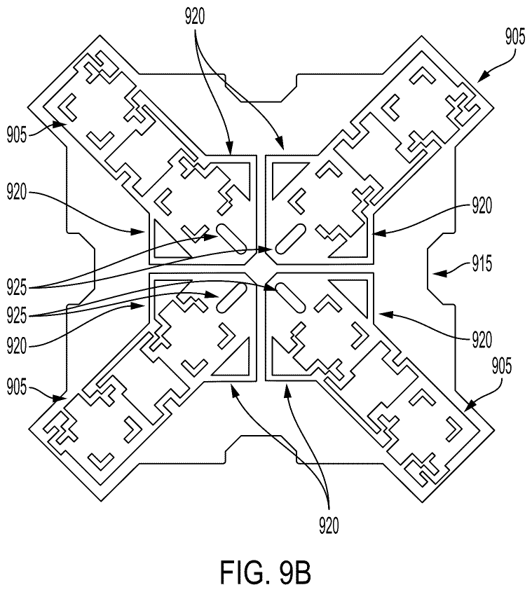

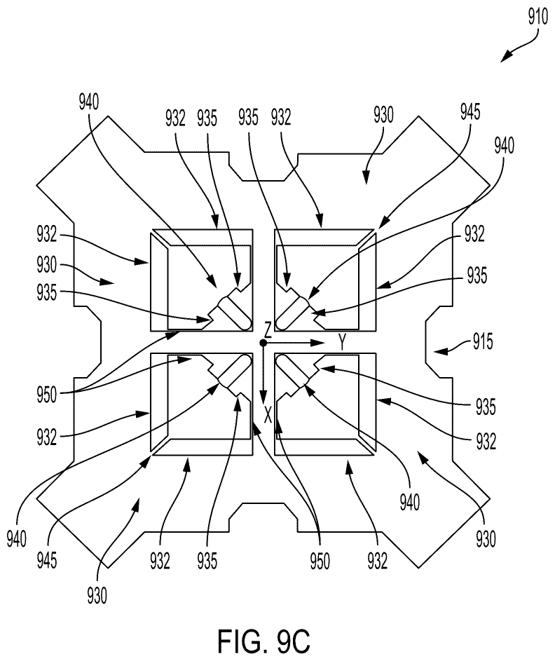

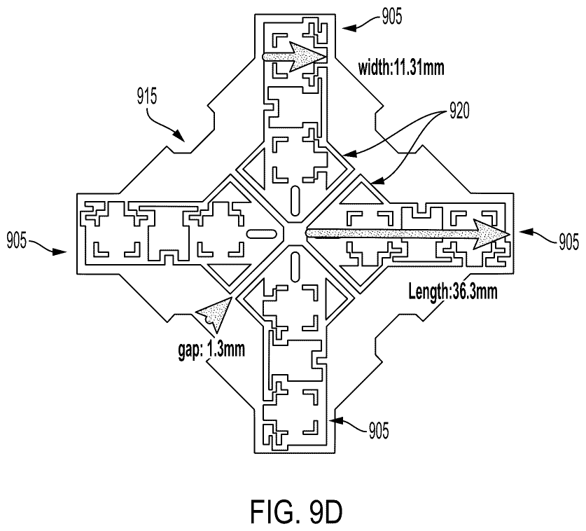

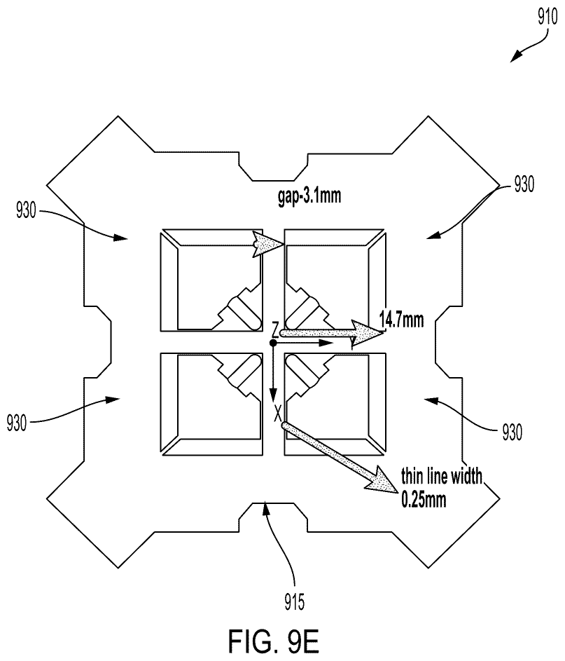

FIG. 9A illustrates an exemplary MB dipole 110 according to the disclosure whereby its frame PCB 915 is shown in transparency to reveal four cloaked dipole arms 905 that are disposed on a lower surface of frame PCB 915, and a second conductor pattern 910 that is formed from a second metal layer on an upper surface of frame PCB 915.

FIG. 9B illustrates four cloaked dipole arms 905 that may be formed of a first metal layer disposed on a lower surface of PCB 915. Each of the dipole arms has a capacitive and inductive pattern that renders the dipole arm 905 transparent to C-Band radiation, thereby enabling MB dipoles 110 to be placed in close proximity to C-band patches 115. Each dipole arm 905 also has a wing structure 920, which increases the gain of MB dipole 110 by increasing the volume of each dipole arm 905 but not where it overlaps with C-Band patches 115. PCB 915 and each dipole arm 905 also have a mounting slot 925, through which a portion of balun stem 125 (not shown) may be inserted for supporting PCB 915.

FIG. 9C illustrates an exemplary second conductor patterns 910 that may be formed of a single second metal layer that is disposed on an upper surface of frame PCB 915. Second conductor patterns 910 has four secondary wing structures 930, each corresponding to one of the MB dipole arms 905. Each secondary wing structure 930 has two feed pads 935 that surround a slot 940 formed in the PCB through which balun stem 125 (not shown) may be inserted so that a solder joint (not shown) may be formed to electrically couple the balun circuitry of balun stem 125 to their corresponding upper wing structures 930.

Each secondary wing structure 930 has two strip conductors 950, one per feed pad 935, that electrically couples each feed pad 935 to a corresponding secondary wing 932. Accordingly, each secondary wing structure 930 has two secondary wings 932 that are separated by a gap 945. Secondary wings 932 overlap with a corresponding wing structure 920 of respective MB dipole arm 905 so that the RF signal conductively coupled to each secondary wing structure 930 from the balun circuitry disposed on balun stem 125 (not shown), and this RF signal gets capacitively coupled to from each secondary wing structure 930 to its corresponding dipole arm 905 and wing structure 920 through frame PCB 915.

FIG. 9D illustrates the four MB dipole arms 905 disposed on the lower surface of frame PCB 915, including example dimensions.

FIG. 9E illustrates four second conductor patterns 910 that may be formed of a single second metal layer that is disposed on an upper surface of frame PCB 915, along with example dimensions.

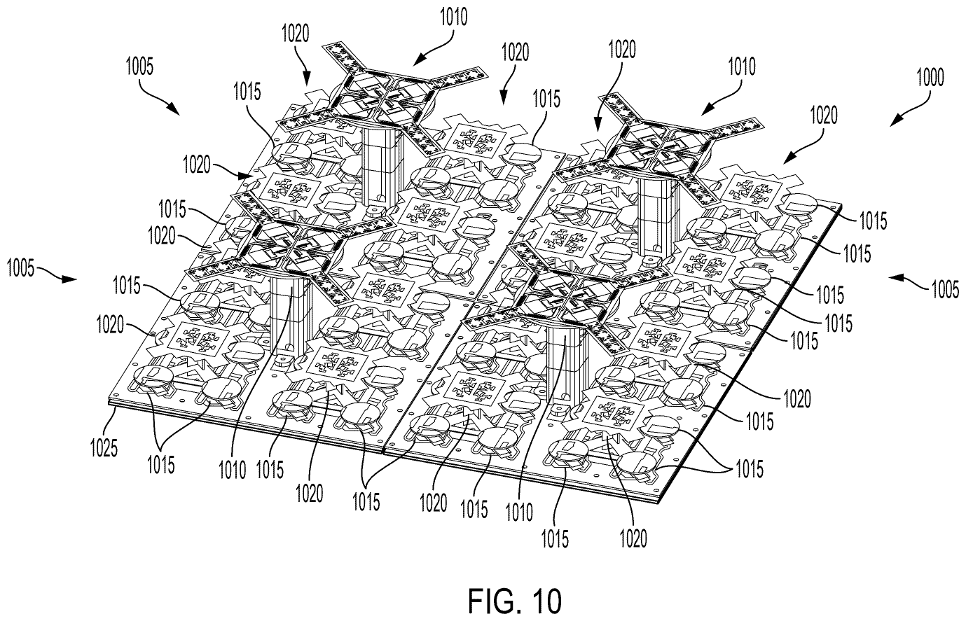

FIG. 10 illustrates a unit cell cluster 1000 according to the disclosure. Unit cell cluster 1000 has four tri-band unit cells 1005 that are disposed on a reflector 1025. Each tri-band unit cell 1005 has a single cloaked Low Band dipole 1010, four cloaked Mid Band dipoles 1020, and sixteen C-Band radiators 1015. The design and construction of cloaked Low Band dipoles 1010 and cloaked Mid Band dipoles 1020 enables their close proximity to each other and to C-Band radiators 1015.

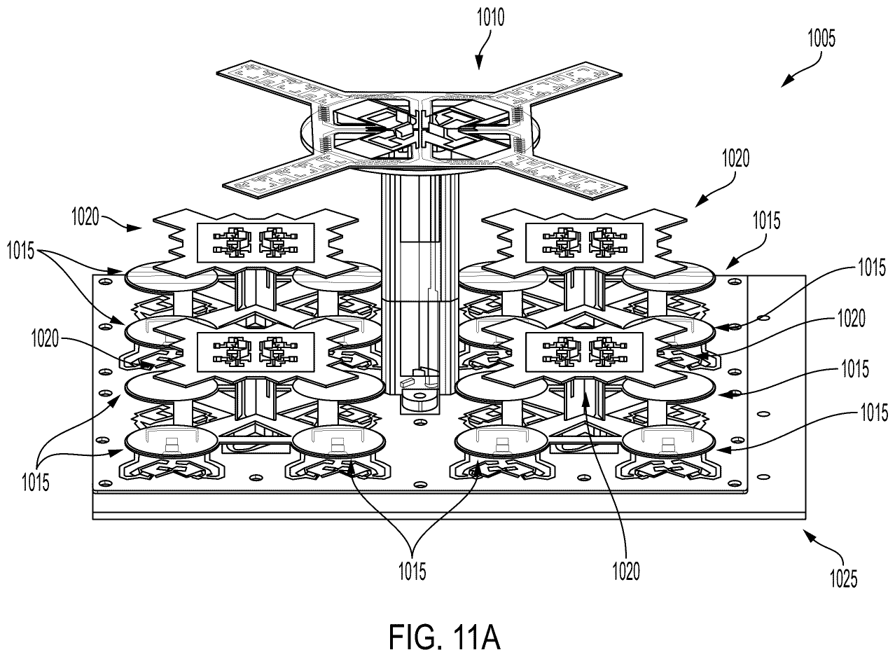

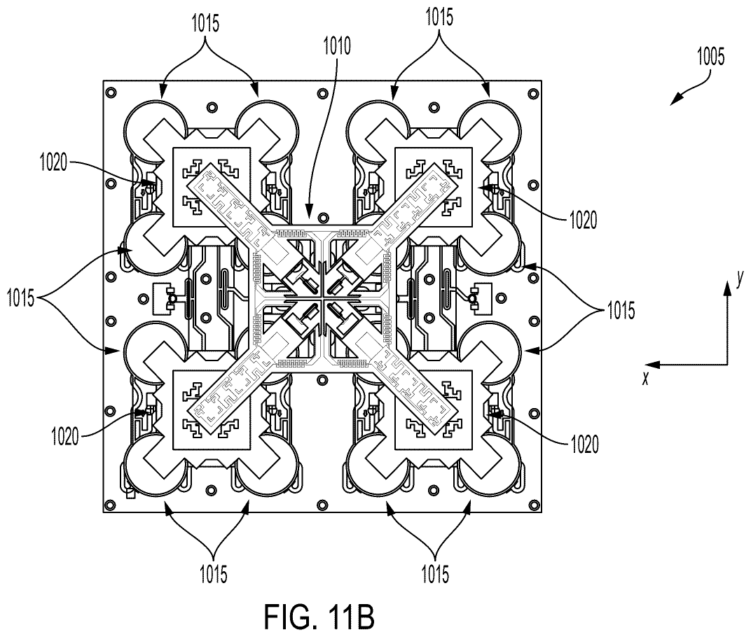

FIG. 11A illustrates a single tri-band unit cell 1005 according to the disclosure. Shown is its cloaked Low Band dipole 1010, four cloaked Mid Band dipoles 1020, and sixteen C-Band radiators 1015. Although cloaked Low Band dipole 1010 and cloaked Mid Band dipoles 1020 are specific to exemplary tri-band unit cell 1005, C-Band radiators 1015 are those disclosed above and illustrated in FIGS. 2-8.

FIG. 11B illustrates tri-band unit cell 1005 from along the z-axis. As shown, each arm of Low Band dipole 1010 is disposed over a Mid Band dipole 1020, and each arm of each Mid Band dipole 1020 is disposed over a C-Band radiator 1015.

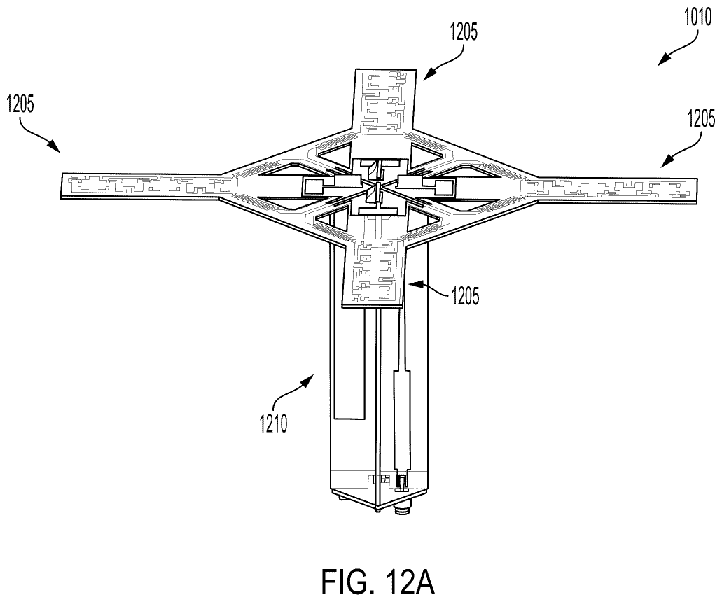

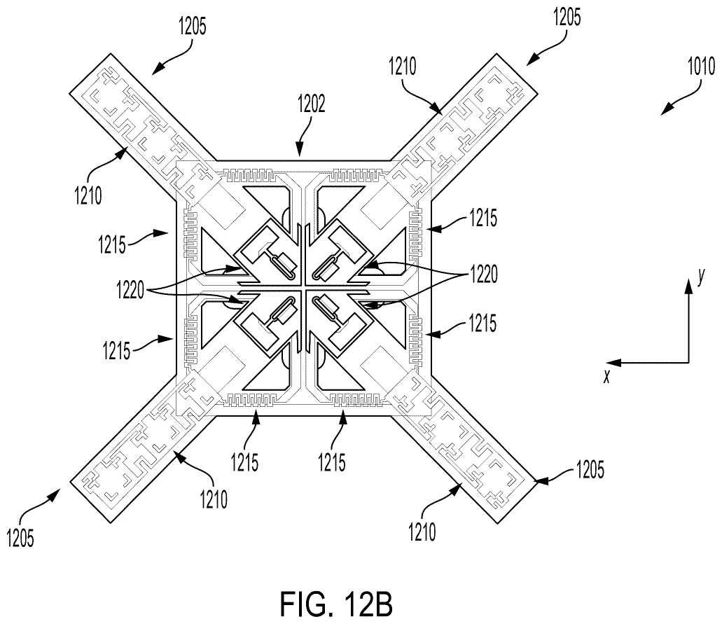

FIG. 12A illustrates exemplary cloaked Low Band dipole 1010 according to the disclosure. Cloaked Low Band dipole 1010 has four Low Band dipole arms 1205 that are mechanically coupled to a balun stem 1210.

FIG. 12B is a view of cloaked Low Band dipole 1010 from along the z-axis. As illustrated, each dipole arm 1205 has a first conductive pattern 1210 that is disposed on a PCB (Printed Circuit Board) 1202 (the side facing reflector 125 (not shown)); and a second conductive pattern 1220 that is disposed on the opposite side of PCB 1202 from first conductive pattern 1210 (facing away from the reflector).

First conductive pattern 1210 for each dipole arm 1205 has a pair of high-gain wings 1215, which increases the gain of cloaked Low Band dipole 1010 while reducing the volume that would be disposed over one or more adjacent Mid Band dipoles 1020 (not shown).

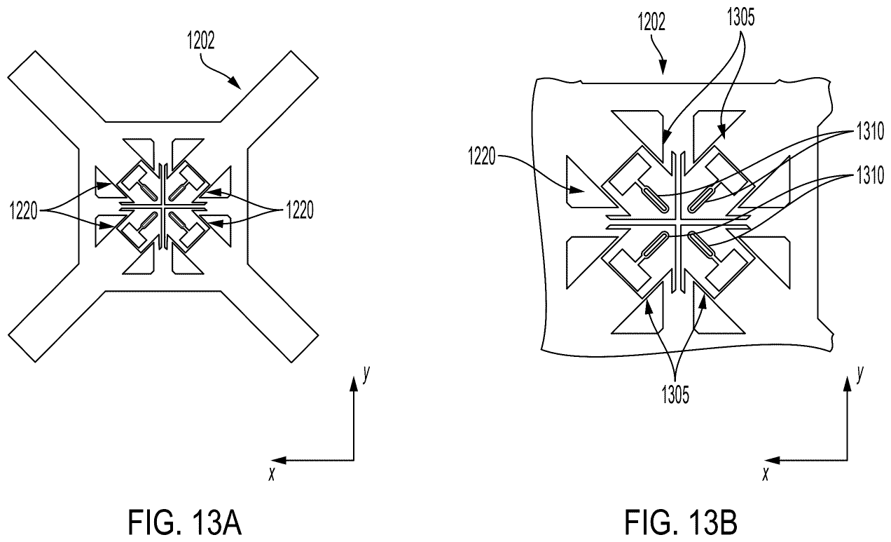

FIG. 13A illustrates PCB substrate 1202 of the cloaked Low Band dipole 1010 with second conductor pattern 1220 disposed thereon.

FIG. 13B is a zoomed-in view of FIG. 13A, showing second conductor pattern 1220 as having four capacitive dipole arm segments 1305, one per dipole arm 1205 (not shown). Each capacitive dipole arm segment 1305 has a contact slot 1310, through which a contact tab of balun stem 1210 (not shown) may protrude so that a solder contact may be made between a contact trace on the contact tab with dipole arm segment 1305.

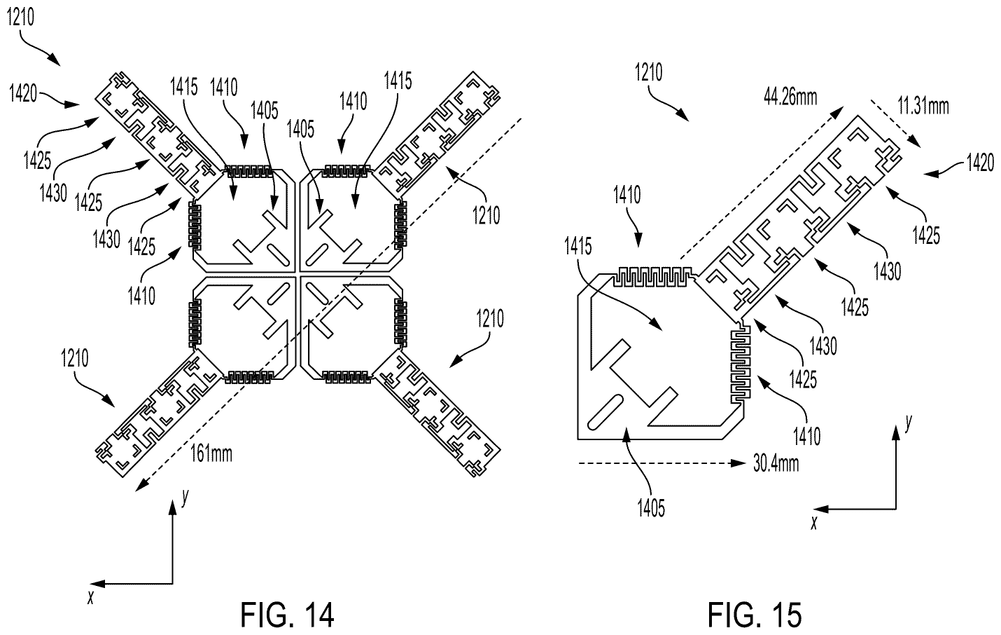

FIG. 14 illustrates first conductive patterns 1210 for all four dipole arms 1205. Each first conductive pattern 1210 has an arm segment 1420 that has an alternating series of inductive segments 1430 and capacitive segments 1425. The innermost capacitive segment 1425 is coupled to two mirrored wing traces 1410, each of which has an inductive meander line, and each of which couples to a capacitive coupling pad 1405. Capacitive coupling pad 1405 capacitively couples to its corresponding dipole arm segment 1305 disposed on the opposite side of PCB 1202. Innermost capacitive segment 1425, mirrored wing traces 1410, and capacitive coupling pad 1405 define an open region 1415.

FIG. 15 illustrates a single first conductive pattern 1210, showing arm segment 1420, wing traces 1410, and capacitive coupling pad 1405, along with exemplary dimensions.

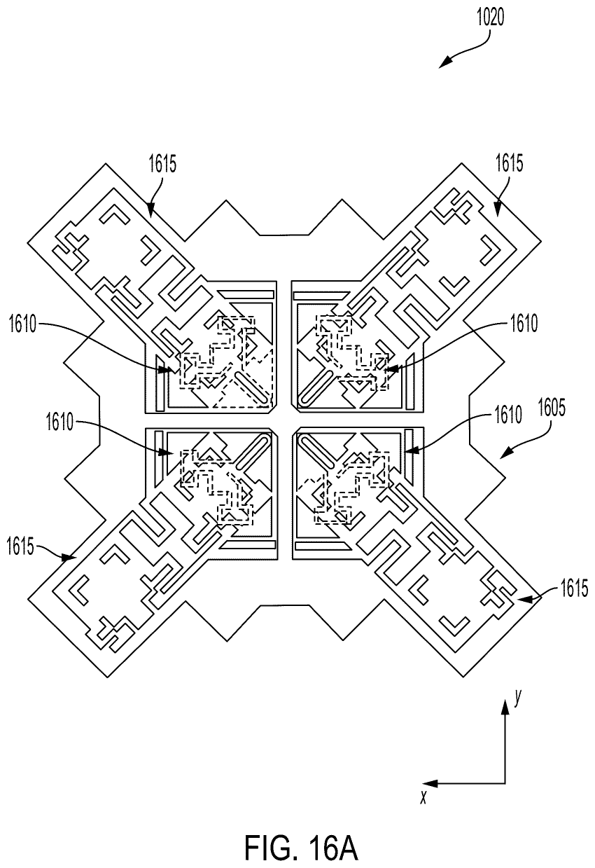

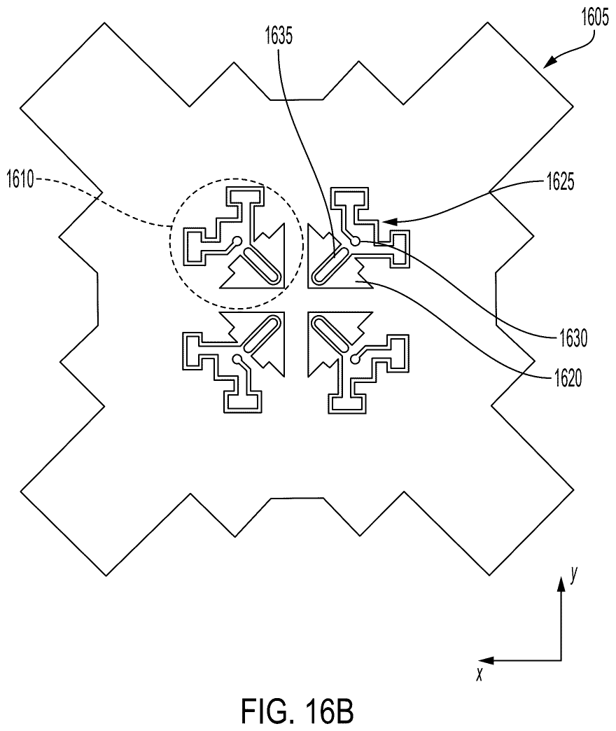

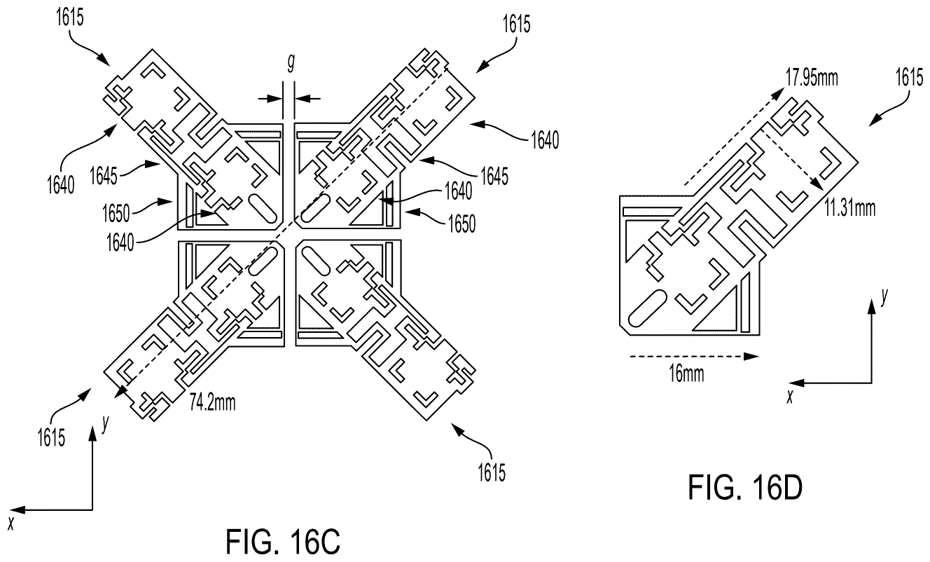

FIG. 16A illustrates exemplary cloaked Mid Band dipole 1020 configured to be integrated into the disclosed triband unit cell 1005, as viewed along the z-axis. Cloaked Mid Band dipole 1020 has a first dipole arm conductive layer 1615 that is disposed on a first side of a PCB substrate 1605, and a second dipole arm conductive layer 1610 that is disposed on a second side of PCB 1605. In this example, the first side of PCB 1605 faces the reflector (not shown).

FIG. 16B illustrates PCB 1605 with four second dipole arm conductive layer 1610 disposed thereon. Each second dipole arm conductive layers 1610 has a capacitive coupling segment 1620 that partly surrounds a contact slot 1635 formed in PCB 1605; and an inductive segment 1625 which runs from capacitive coupling segment 1620 to a via 1630, which electrically couples to corresponding first dipole arm conductive layer 1615. Contact slot 1635 is configured to accept a contact tab of a balun stem (not shown) so that a solder contact may be made between a contact trace (not shown) on the contact tab with capacitive element 1620.

FIG. 16C illustrates four first dipole arm conductive layers 1615, as they would be disposed on PCB 1605 (not shown). Each first dipole arm conductive layer 1615 has an alternating arrangement of capacitive segments 1640 and an inductive element 1645. Each second dipole arm conductive layer 1615 further has a pair of high gain wing traces 1650.

FIG. 16D illustrates a single first dipole arm conductive layer 1615, including exemplary dimensions.

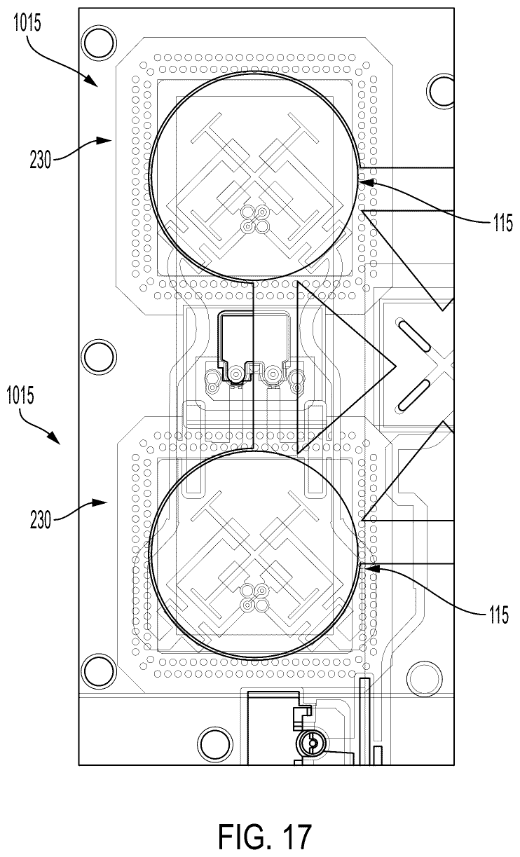

FIG. 17 illustrates two C-Band radiators 1015, showing two patch antenna elements 115 disposed atop two cavity cup frames 230. The patch antenna elements 115 are disposed above reflector 1025 and the cavity cup frames are disposed below reflector 1025. As used herein, “above” means located at a first side of reflector 1025 and “below” means located at a second side of reflector 1024, wherein the first side is the side on which Low Band dipole 1010 and Mid Band dipoles 1020 are disposed, and the second side is opposite the first side.

1. A unit cell for a multiband antenna, comprising:
a reflector;
a first frequency dipole having four first frequency dipole arms;
a plurality of second frequency dipoles each having four second frequency dipole arms; and
a plurality of third frequency radiators, each third frequency radiator having a patch antenna element disposed above the reflector and a cavity cup frame disposed below the reflector,
wherein each of the first frequency dipole arms is disposed above a corresponding one of the plurality of second frequency dipoles, and wherein each of the second frequency dipole arms is disposed above a corresponding one of the plurality of third frequency radiators.

2. The unit cell of claim 1, wherein the first frequency comprises a Low Band, a second frequency comprises a Mid Band, and the third frequency comprises a C-Band.

3. The unit cell of claim 1, wherein the first frequency dipole comprises:
a first frequency first conductive pattern disposed on a first side of a first PCB (Printed Circuit Board); and
a first frequency second conductive pattern disposed on a second side of the first PCB.

4. The unit cell of claim 3, wherein the first frequency first conductive pattern comprises, for each first frequency dipole arm:
an arm segment having alternating capacitive segments and inductive segments;
two mirrored high gain wing traces; and
a capacitive coupling pad,
wherein an innermost capacitive segment, the two mirrored high gain wing traces, and the capacitive coupling pad define an open region.

5. The unit cell of claim 4, wherein each of the mirrored high gain wing traces comprises an inductive meander trace.

6. The unit cell of claim 4, wherein the first side of the first PCB faces the reflector.

7. The unit cell of claim 4, wherein each of the plurality of second frequency dipoles comprises:
a second frequency first conductive pattern disposed on a first side of a second PCB; and
a second frequency second conductive pattern disposed on a second side of the second PCB.

8. The unit cell of claim 7, wherein the second frequency first conductive pattern comprises, for each second frequency dipole arm:
a plurality of alternating second frequency capacity segments and second frequency inductive segments; and
a pair of mirrored second frequency high gain wing traces.

9. The unit cell of claim 8, wherein the second frequency second conductive pattern comprises, for each second frequency dipole arm:
a second frequency capacitive coupling segment; and
a second frequency inductive trace electrically coupled to the second frequency capacitive coupling segment, the second frequency inductive trace being coupled to a via that electrically couples to the corresponding second frequency first conductive pattern.

10. A unit cell cluster for a multiband antenna, comprising:
a plurality of unit cells, wherein each of the plurality of unit cells comprises:
a reflector;
a single cloaked Low Band dipole having four Low Band dipole arms;
a plurality of cloaked Mid-Band dipoles, wherein each of the plurality of cloaked Mid-Band dipoles has four Mid-Band dipole arms; and
a plurality of C-Band radiators, each C-Band radiator having a patch antenna element disposed above the reflector and a cavity cup frame disposed below the reflector,
wherein each of the Low Band dipole arms is disposed above a corresponding one of the plurality of Mid-Band dipoles, and wherein each of the Mid-Band dipole arms is disposed above a corresponding one of the plurality of C-Band radiators.
